(19) United States
(12) Patent Application Publication
(10) Pub. No.: US 2024/0357473 A1
(43) Pub. Date: Oct. 24, 2024

(54) AUTHENTICATION MANAGEMENT AND WIRELESS ACCESS CONTROL VIA CONFIGURATION SETTINGS

(71) Applicant: Charter Communications Operating, LLC, St. Louis, MO (US)

(72) Inventors: Ahmed Bencheikh, Lorton, VA (US); Venkata R. Divvi, Centennial, CO (US)

(21) Appl. No.: 18/138,248

(22) Filed: Apr. 24, 2023

(51) Int. Cl. H04W 48/06; H04W 12/06; H04W 12/08; H04W 28/02

(52) U.S. Cl. CPC H04W 48/06; H04W 12/06; H04W 12/08; H04W 28/0231

(57) ABSTRACT

A network environment includes a communication management resource. The communication management resource receives a request from a first communication device for access to a remote network via a wireless communication link. Prior to authenticating the first communication device to access the remote network through a first wireless access point, the communication management resource retrieves wireless access control information indicating how to control wireless connectivity with the first wireless access point. The communication management resource then controls the access associated with the first communication device through the first wireless access point in accordance with the wireless access control information.

### BACKGROUND

Conventional out of band message-based solutions are implemented post authentication phase. For example, according to conventional techniques, a new or existing mobile communication device may be authenticated to use a respective network. After notifying the communication device that it has been authenticated and completion of authentication, a conventional wireless network then implements respective processing to support communications associated with the authenticated communication device.

Most of the existing wireless network service providers (i.e., network operators) provide wireless Internet access to a wide range of subscribers belonging to various classes of service subscriptions, which typically includes subscribers roaming between partner networks and traffic offloading from wide area wireless networks, using advanced wireless protocols. These roaming partnerships between so-called MSO's and other traditional wireless network operators provide their subscribers seamless roaming. The conventional wireless access points deployed in the field support a wide range of subscribers belonging to various service classes.

### BRIEF DESCRIPTION OF EMBODIMENTS

This disclosure includes the observation that conventional wireless access points across different wireless network service providers are only able to differentiate the subscribers and provide priority access to certain users based on the class of service subscription and dynamic network conditions after authentication of a respective communication device for use of the wireless network. In cases where subscriber density is high or varying sporadically at a different times of the day/season may impact priority subscriber access, resulting in poor performance and poor user experience due to overload conditions on an access point.

Embodiments herein provide novel ways of providing improved wireless communications to one or more mobile communication devices in a network environment via pre-authentication processing.

For example, a communication management resource as discussed herein receives a request from a first communication device for access to a remote network via a wireless communication link. Prior to authenticating the first communication device to access the remote network through a first wireless access point, the communication management resource analyzes wireless access control information indicating how to control wireless connectivity with the first wireless access point. The communication management resource controls the wireless access associated with the first communication device through the first wireless access point in accordance with the wireless access control information.

As further discussed herein, the request from the first communication device may be a discovery request generated by the first communication device to learn of available access points.

The request from the first communication device can include any suitable information. For example, in one example, the request may include: a service provider identity value indicating an identity of a first wireless network service provider to which a user of the first communication device subscribes. The first wireless network service provider may be one of multiple wireless network service providers supported by the first wireless access point. To control access, the communication management resource associated with the first wireless access point can be configured to: via the wireless access control information, determine a limit value associated with the first wireless network service provider, the limit value indicating a number of communication devices supported by the first wireless access point for the for wireless network service provider. The communication management resource can be configured to further determine a current load value for the first wireless network service provider. The current load value indicates a current number of communication devices associated with the first wireless network service provider currently being provided access through the first wireless access point to the remote network. In response to detecting that the current load value is less than the communication device limit value (or other metric such as available bandwidth value), the communication management resource proceeds with authentication of the first communication device to establish the wireless communication link with the first wireless access point, providing the first communication device the requested wireless connectivity.

Alternatively, the communication management resource determines a current load value on the first wireless access point for the first wireless network service provider. The current load value indicates a current number of communication devices associated with the first wireless network service provider currently being provided access through the first wireless access point to the remote network. In response to detecting that the current load value is greater than or equal to the limit value, the communication management resource associated with the first wireless access point prevents authentication of the first communication device to establish the wireless communication link with the first wireless access point. In other words, the communication management resource can be configured to reject the first communication device from being provided wireless access through the first wireless access point if the current load of communication devices of a second wireless network service provider on the first wireless access point is equal to or greater than the device limit value.

In accordance with further examples, prior to receiving the request, the communication management resource transmits configuration information (a.k.a., discovery information) indicating supported service providers and networks from the first wireless access point to the first communication device. The transmitted configuration information can be configured to indicate identities of multiple wireless network service providers supported by the first wireless access point. The discovery information can be configured to include the identity of the first wireless network service provider to which a user of the first communication device subscribes.

In accordance with still further examples, controlling the access associated with the first communication device in accordance with the wireless access control information may include: via the wireless access control information, detecting that the first wireless access point has reached a load limit associated with providing wireless access to communication devices subscribing to a first wireless network service provider; and in response to reaching the load limit: i) producing a neighbor list indicating a group of alternative wireless access points in a vicinity of the first wireless access point, and ii) communicating notification of the neighbor list to the first communication device requesting wireless access. Still further, as discussed herein, the notification can be configured to prompt the first communication device to access the remote network via a second wireless access point as specified by the neighbor list.

Yet further examples include the communication management resource, via the wireless access control information, detecting that the first wireless access point has reached a load limit associated with providing wireless access to communication devices subscribing to a first wireless network service provider. In response to detecting the load limit, the communication management resource can be configured to transmit a rejection message to the first communication device. The rejection message indicates denial of the access through the first wireless access point to the remote network, potentially causing a redirect of the first communication device to another wireless access point.

In accordance with further examples, the communication management resource can be configured to control the access based at least in part on authentication management hardware that analyzes the request from the first communication device to determine whether to proceed with authentication of the first communication device to use first wireless access point.

Controlling the access associated with the first communication device may further include: subsequent to eventually authenticating the first communication device, and in accordance with the wireless access control information, providing the first communication device the access to the remote network. In one example, the communication management resource receives an update to the wireless access control information. In other words, the wireless access control information may change over time. In response to detecting that the first wireless access point is no longer allowed to access through the first wireless access point, the communication management resource communicates a communication link termination notice to the first communication device. The communication link termination notice notifies the first communication device of a termination of the wireless access, causing a redirect of the communication device to another wireless access point.

In accordance with yet further examples, controlling the access associated with the first communication device in accordance with the wireless access control information can be configured to include: in response to a first wireless network service provider detecting an inability of the first wireless access point to provide the first communication device a particular bandwidth throughput level of quality as specified by the wireless access control information, from the communication management resource, communicating a message to communication management hardware associated with a second wireless network service provider, the first communication device may be a subscriber associated with the second wireless network service provider. The message can be configured to request permission for the first wireless access point to provide the first communication device a reduced bandwidth throughput level of quality with respect to the particular bandwidth throughput level of quality as specified by the wireless access control information. In response to receiving the permission from the second wireless network service provider, the communication management functions as discussed herein control the first wireless access point or other wireless access point to provide the first communication device the reduced bandwidth throughput level of quality access to the remote network.

Note that any of the resources as discussed herein can include one or more computerized devices, mobile communication devices, servers, base stations, wireless communication equipment, communication management systems, workstations, user equipment, handheld or laptop computers, or the like to carry out and/or support any or all of the method operations disclosed herein. In other words, one or more computerized devices or processors can be programmed and/or configured to operate as explained herein to carry out the different embodiments as described herein.

Yet other embodiments herein include software programs to perform the steps and operations summarized above and disclosed in detail below. One such embodiment comprises a computer program product including a non-transitory computer-readable storage medium (i.e., any computer readable hardware storage medium) on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium such as an optical medium (e.g., CD-ROM), floppy disk, hard disk, memory stick, memory device, etc., or other a medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, embodiments herein are directed to a method, system, computer program product, etc., that supports operations as discussed herein.

One embodiment includes a computer readable storage medium and/or system having instructions stored thereon to facilitate wireless connectivity. The instructions, when executed by computer processor hardware, cause the computer processor hardware (such as one or more co-located or disparately processor devices) to: receive a request from a first communication device for access to a remote network via a wireless communication link; prior to authenticating the first communication device to access the remote network through a first wireless access point, retrieve wireless access control information indicating how to control wireless connectivity of multiple communication devices with the first wireless access point; and control the access associated with the first communication device via the first access point in accordance with the wireless access control information.

The ordering of the steps above has been added for clarity sake. Note that any of the processing steps as discussed herein can be performed in any suitable order.

Other embodiments of the present disclosure include software programs and/or respective hardware to perform any of the method embodiment steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of supporting different wireless access and services. However, it should be noted that embodiments herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of embodiments herein (BRIEF DESCRIPTION OF EMBODIMENTS) purposefully does not specify every embodiment and/or incrementally novel aspect of the present disclosure or claimed invention(s). Instead, this brief description only presents general embodiments and corresponding points of novelty over conventional techniques. For additional details and/or possible perspectives (permutations) of the invention(s), the reader is directed to the Detailed Description section (which is a summary of embodiments) and corresponding figures of the present disclosure as further discussed below.

### BRIEF DESCRIPTION OF THE DRAWINGS

FIG. 1 is an example diagram illustrating a wireless network environment supporting priority wireless access control amongst visitor communication devices and home network communication devices as discussed herein.

FIG. 2 is an example diagram illustrating wireless access configuration settings for visitor communication devices versus home network communication devices as discussed herein.

FIG. 3 is an example data flow diagram illustrating wireless access control for a visitor communication device as discussed herein.

FIG. 4 is an example diagram illustrating a wireless network environment supporting priority wireless access control amongst visitor communication devices and home network communication devices as discussed herein.

FIG. 5 is an example diagram illustrating wireless access configuration settings for visitor communication devices versus home network communication devices as discussed herein.

FIG. 6 is an example data flow diagram illustrating wireless access control for a visitor communication device as discussed herein.

FIG. 7 is an example diagram illustrating a wireless network environment supporting priority wireless access control amongst security agency user communication devices versus home network communication devices as discussed herein.

FIG. 8 is an example data flow diagram illustrating wireless access control for a security agency user communication device as discussed herein.

FIG. 9 is an example data flow diagram illustrating wireless access control for a security agency user communication device as discussed herein.

FIG. 10 is a diagram illustrating example computer architecture operable to execute one or more operations as discussed herein.

FIG. 11 is an example diagrams illustrating methods as discussed herein.

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

### DETAILED DESCRIPTION

As previously discussed, a service provider network includes a communication management resource. The communication management resource receives notification of a request from a first communication device for access to a remote network via a wireless communication link. Prior to authenticating the first communication device to access the remote network through a first wireless access point in the service provider network, the communication management resource retrieves wireless access control information indicating how to control wireless connectivity via the first wireless access point. The communication management resource then controls the wireless access associated with the first communication device through the first wireless access point or other wireless access points in accordance with the wireless access control information.

As discussed herein, a communication management resource identifies a subscriber's class of service subscription information and category information before fully associating/authenticating) with respect to the service provider's wireless network (and corresponding wireless access points) and applying appropriate connection admission control & client load balancing techniques. If wireless services such as bandwidth is unavailable, the communication management resource redirects the clients to available neighbor access points in that coverage area.

In one example, when a particular wireless access point reaches its max allowed threshold of concurrent clients or bandwidth to serve, the overload condition is mitigated and controlled by redirecting new clients to neighbor access points. The load balancing as discussed herein may be managed through static wireless access configuration information available to the wireless access point, where the max allowed clients per radio (Single/Dual/Tri radio) or total clients per access point balance the number of clients per access point radio. An application server can be configured to compile the details of a neighbor access point by measuring the RSSI (Received Signal Strength Indicator) of wireless spectrum signals at regular intervals or during channel scans by the wireless access points. A communication management resource associated with the wireless access points keeps tracks how many clients are connected to each access point and, when a configured limit for visitor communication devices is reached, the communication management resource controls the limits by not responding to probe requests and authentication requests from communication devices. This prevents new communication devices from using wireless services at wireless access points experiencing congestion with respect to providing wireless services to current wirelessly connected communication devices.

The techniques as discussed herein do not need to differentiate clients and their subscriptions because, once an access point (or radio) reaches its max allowed clients, then all subsequent client requests will be ignored irrespective of whether the new client device is the service provider's home subscriber (or) visiting subscriber from roaming partners/other MSO network.

Passpoint, also known as Hotspot 2.0, is an IEEE 802.11u standard-based protocol to enable network discovery, seamless connectivity, and roaming between WLAN/Wi-Fi™ and cellular networks. It automatically provides cellular network-like connectivity to a WLAN (Wireless Local Area Network) with no manual intervention required and offloads the traffic to the Wi-Fi™ network.

A conventional Passpoint supported AP (Access Point) advertises the available network services of service providers to communication devices at regular intervals using beacon frames. Via a probe request, a mobile device can be configured to communicate a request for capabilities and services provided by the access point prior to associating with the respective AP. With the information (such as supported wireless services) received from the AP, the communication device makes the decision to connect to the AP or not.

In Passpoint (aka Hotspot 2.0), network discovery and selection are automated through protocol-based discovery and selection procedures. Device decision to associate the WLAN is linked to credentials registered or profiled by service.

Certain proposed solutions as discussed herein include enhancing one or more of client devices and/or access points with appropriate functionality (such as hardware logic, software, etc.) to support public action frames exchange, which helps to support graceful connection admission control and client load balancing during various stages of the client's connection states.

Client devices exchange custom Public Action Frames with AP's which are advertising the hotspot 2.0 interworking capability, with query parameters set to the client service provider identity. The receiving access point processes the received query, checks the CAC (Connection Admission Control) and CLB (Client Load Balancing) policy thresholds at that point, and responds accordingly. As further discussed herein, an AP requesting a communication device's request for service can be configured to send a neighbor report with a list of one or more recommended access points for use by the rejected client device for alternative wireless connectivity.

Service providers may deploy wireless access points nationwide, serving a wide range of end users covering Out-of-home, SMB, residential users, MDU's, hospitality, etc., including subscribers inbound roaming (such as visitor mobile communication devices) for roaming partners. Most roaming subscriber's mobile devices are provisioned with hotspot 2.0 credential profiles which will allow seamless connectivity to Wi-Fi while roaming.

Yet further, as discussed herein, a communication management resource can be configured to enhance the access point service logic to detect the subscriber's class of service and subscription during network discovery (such as prior to authentication) and allocate priority access to certain users based on their profile or class of service. The service logic as discussed herein is dynamic and can be implemented based on the AP's capacity threshold, which is potentially pre-configured per the subscriber's class of service, present load, and policy. The input parameters to build the dynamic service logic as further discussed herein can be sourced from one or more edge elements such as local Message Information Block (MIB), upstream analytics server, and policy engine, etc.

There are several use cases for the class of service subscription-based priority access as discussed herein including: i) Priority access to home network subscribers over visiting subscribers from roaming partners. ii) Event respondent users to get priority access during high priority situations, authenticate against an emergency respondent authentication server provided by a government agency or trusted 3rd party, and grant it priority access and higher QoS. iii) Priority access to Security agency users to Service provider Wi-Fi network (wireless network) during a security event scenarios.

The desired functionality can be achieved in any suitable manner such as via:
1. Enhancing the Access Point implementation with embedded service logic and integration with backend systems.
2. An enhanced AAA-based solution.

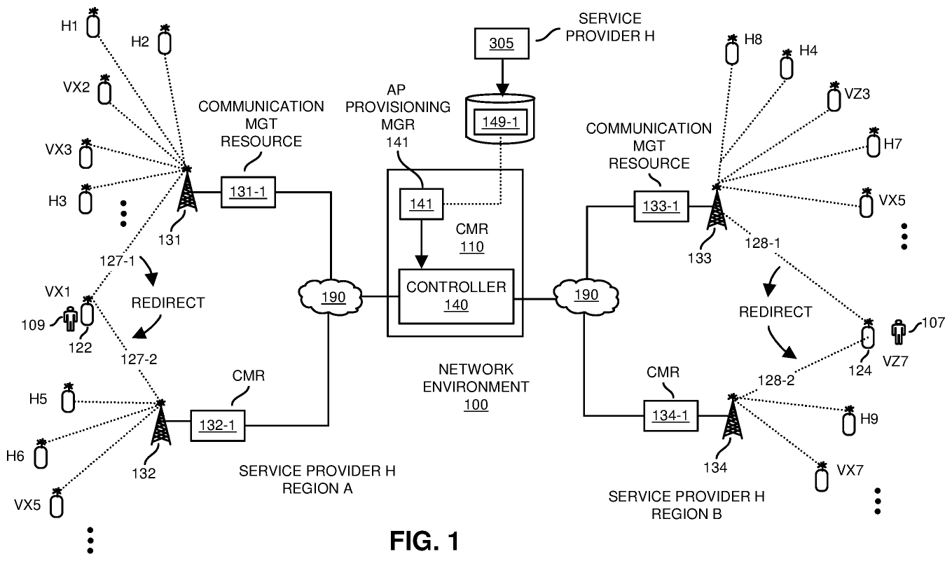

Now, more specifically, FIG. 1 is an example diagram illustrating a wireless network environment supporting priority wireless access control amongst visitor communication devices and home network communication devices as discussed herein. As shown, in this example embodiment, network environment 100 includes multiple wireless access points including wireless access point 131, wireless access point 132, wireless access point 133, wireless access point 134, etc. Each of the wireless access points provides one or more communication devices wireless access to the network 190.

Assume that the wireless access point 131 and corresponding communication management resource 131-1 currently provide one or more communication devices such as communication device H1 (home or non-visiting subscriber of wireless network service provider H), communication device H2 (subscriber of service provider H), communication device H3 (subscriber of service provider H), . . . , visitor communication device the VX2 (subscriber of wireless network service provider X), visitor communication device the VX3 (subscriber of wireless network service provider X), etc., wireless access to the network 190.

As discussed herein, note that the wireless network service provider H may provide wireless services to visitor communication device that subscribe to other service providers such as wireless network service provider X, wireless network service provider Z, etc.

As further shown, the wireless access point 132 and corresponding communication management resource 132-1 currently provide one or more communication devices such as communication device H5 (subscriber of service provider H), communication device H6 (subscriber of service provider H), . . . , visitor communication device VX5 (subscriber of service provider X), etc., wireless access to the network 190.

Wireless access point 131 and wireless access point 132 reside in region A supported by the service provider H (a.k.a., home service provider). Communication devices in region can potentially connect to either wireless access point 131 or wireless access point 132 to access the network 190 depending on load conditions.

The wireless access point 133 and corresponding communication management resource 133-1 currently provide one or more communication devices such as communication device H4 (subscriber of service provider H), communication device H7 (subscriber of service provider H), communication device H8 (subscriber of service provider H), . . . , visitor communication device VX5 (subscriber of service provider X), visitor communication device the VZ3 (subscriber of service provider Z), etc., wireless access to the network 190.

The wireless access point 134 and corresponding communication management resource 134-1 currently provide one or more communication devices such as communication device H9 (subscriber of service provider H), . . . , visitor communication device the VX7 (subscriber of service provider X), etc., wireless access to the network 190.

Wireless access point 133 and wireless access point 134 reside in region B supported by the service provider H (a.k.a., home service provider). Communication devices in region can potentially connect to either wireless access point 133 or wireless access point 134 depending on load conditions.

As further shown, the network environment 100 further includes communication management resource 110. Communication management resource 110 includes controller 140, access point provisioning manager 141, etc.

In general, service provider H (via entity 305) produces corresponding configuration settings 149-1 (wireless access control settings) indicating wireless access rules of providing different communication devices access to the network 190 through respective wireless access points. As further discussed herein, the configuration settings 149-1 associated with the service provider H can be configured to indicate how to partition usage of available amongst home communication devices (subscribers of the wireless network service provider H) and visitor communication devices operated by wireless network service provider X, wireless network service provider Z, etc.

As its name suggests, the access point provisioning manager 141 provisions use of the different wireless access points to provide wireless access services to the different communication devices based on the configuration settings 149-1. The controller 140 enforces the configuration settings 149-1 as further discussed herein.

Note that the implementation of the configuration settings 149-1 can be configured to provide load-balancing amongst the different wireless access points prior to authentication of the respective communication devices requesting access.

Note further that any of the resources as discussed herein can be implemented via communication management hardware, software, or a combination of hardware and software. For example, each of the communication devices can be implemented as communication management hardware, communication management software, or a combination of communication management hardware and communication management software; each wireless access point can be implemented as wireless access point hardware, wireless access point software, or a combination of wireless access point hardware and wireless access point software; controller 140 can be implemented as controller hardware, controller software, or a combination of controller hardware and controller software; access point provisioning manager can be implemented as access point provisioning and sure hardware, access point provisioning manager software, or a combination of access point provisioning manager hardware and access point provisioning manager software; entity 305 generating the respective configuration settings 149-1 can be implemented as configuration setting generator hardware, configuration settings generator software, or a combination of configuration settings generator hardware and configuration setting generator software; and so on.

Note that the combination of FIGS. 1-3 illustrate a corresponding access point based solution which the corresponding wireless access points provide wireless access to one or more communication devices.

### AP Based Solution

One solution described in this section is for one of the use cases for example Priority access to home network subscribers over visiting subscribers from roaming partners.

Operator-H (i.e., service provider H or home network service provider) deploys wireless access points (such as Wi-Fi™ access points) in two different regions A and B providing Wi-Fi™ or other type of wireless connectivity to the wide range of home network subscribers (subscribers of service provider H) as well as allowing roaming or visitor subscribers (subscribers of service provider X, service provider Z, etc.). Note that the wireless access points can be configured to support any suitable wireless communication protocol.

In region A, the potential for roaming subscribers from one of the roaming partners is high. For example, in a city like New York, there is a possibility of subscribers from service provider X attempting to use wireless services provided by the wireless network service provider H during Friday evening restaurant hours or weekend busy shopping hours. In traditional service provider H operation, the wireless access point 131 will allow all the subscribers from home as well as visiting subscribers to access the network 190. This may potentially lead to access point overload conditions if too many communication devices are allowed wireless access through a respective wireless access point. The overload conditions result in poor wireless performance and a bad user experience for all subscribers served by that wireless access point. Accordingly, the overload will create a bad user experience for home subscribers in their home network region.

As further described herein, for region A, the service provider H wants to restrict roaming subscribers (visitor communication devices) belonging to a roaming partner network (such as wireless network service provider X) on any given wireless access point in region A limited to N (such as limit of 5). Similarly, for region B, assume that the service provider H wants to restrict roaming subscribers belonging to a roaming partner (service provider X) on any given wireless access point in region B no more than 3 users (or some other value). For region B, the service provider H wants to restrict roaming subscribers belonging to a roaming partner (service provider Z) on any given wireless access point in region B no more than 2 users (or some other value).

In such an instance, the service provider H produces the corresponding configuration settings 149-1 to indicate the limits for home communication devices and visitor communication devices and corresponding users.

As further discussed herein, any new client network discovery attempts by respective communication devices will be processed by a receiving wireless access point based on configuration settings provided by corresponding communication management resource 110. For example, whether or not a respective wireless access point will provide wireless services to a requesting visitor communication device depends upon the corresponding threshold limits as well as the current load of the wireless access point. More specifically, if a respective wireless access point is overloaded and is unable to accept a new wireless access requests, the corresponding requesting visitor communication device will be redirected to another wireless access point for the requested wireless service such as prior to authentication of the that visitor communication device.

In this example, as further shown and as discussed below, the visitor communication device 122 attempts to establish wireless connectivity and corresponding access to the wireless network 190 through the wireless access point 131. In response to detecting that the wireless access point 131 experiences an overload condition such as that the wireless access point already provides a maximum #of visitor communication devices access to the network 190, the one or more entities in the network environment 100 can be configured to initiate a respective redirect of that visitor communication device 122 to another wireless access point (such as wireless access point 132 in this example) that is able to provide the requested wireless service.

As further shown, the visitor communication device 124 (V27) operated by user 107 can be configured to request wireless access through the wireless access point 133. In response to detecting that the wireless access point 133 experiences an overload condition such as that the wireless access point 133 already provides a maximum #of visitor communication devices associated with service provider Z access to the network 190, the one or more entities in the network environment 100 initiate a respective redirect of that visitor communication device 124 and corresponding user 107 to another wireless access point (such as wireless access point 134 in this example) that is able to provide the requested wireless service. Additional details of providing load-balancing and wireless access control are further discussed below.

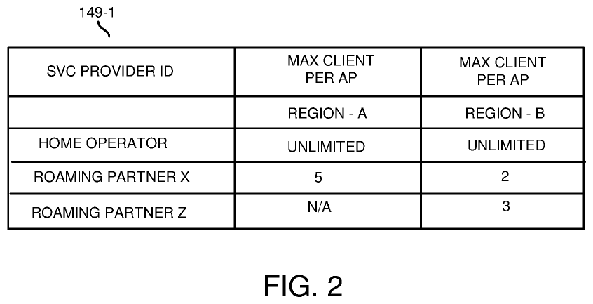

FIG. 2 is an example diagram illustrating wireless access configuration settings for visitor communication device and home network communication devices as discussed herein.

In this example, as previously discussed, the service provider such as operator H (a.k.a., service provider H) implements multiple wireless access points in multiple regions. The configuration settings 149-1 indicate the wireless access control provided by the service provider H to the different types of supported communication devices (such as home devices or visitor communication devices) in different regions.

More specifically, the configuration settings 149-1 indicate that the service provider H supports: i) an unlimited number of communication devices that are operated by its own subscribers (home subscribers) for wireless region A, ii) a limited number of 5 communication devices that are operated by visitor subscribers associated with roaming partner X for wireless region A, and iii) no communication devices that are operated by visitor subscribes associate with roaming partner Z for wireless region A.

Configuration settings 149-1 in this example further indicates that the service provider H supports: i) an unlimited number of communication devices that are operated by its own subscribers (home subscribers) for wireless region B, ii) a limited number of 2 communication devices that are operated by visitor subscribers associated with roaming partner X for wireless region A, and iii) a limited number of 3 communication devices that are operated by visitor subscribers associated with roaming partner Z for wireless region A.

Note that security agency users or emergency respondents can be provided unlimited/highest priority access.

Additionally, note that the limits as discussed herein can be implemented in terms of bandwidth instead of number of communication devices supported by a wireless access point.

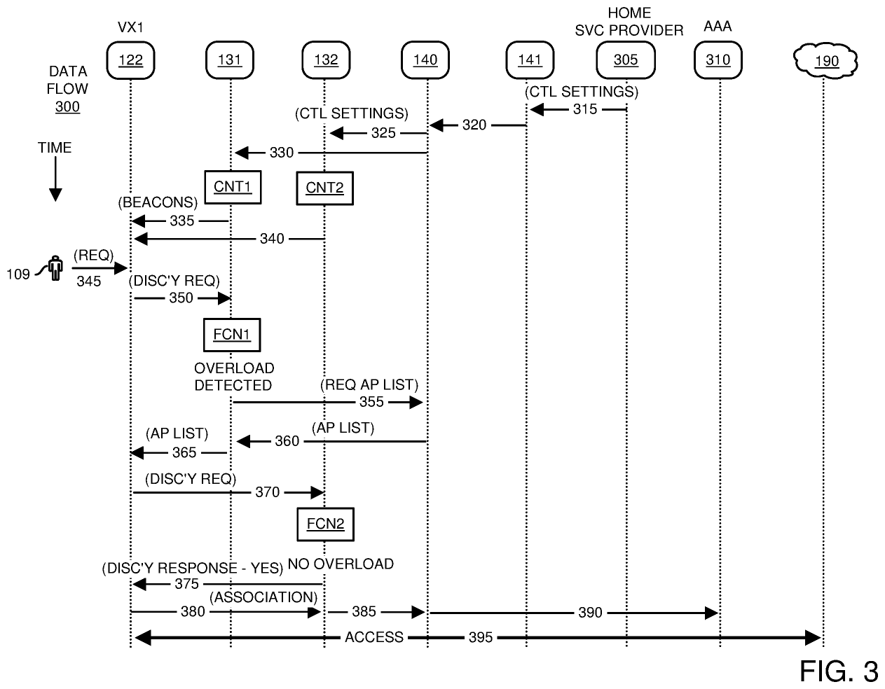

FIG. 3 is an example data flow diagram illustrating wireless access control for a visitor communication device as discussed herein.

In general, wireless access control can include the following operations:
1. Operator H performs a per region-based wireless connection admission control and client load balancing/provisioning rules, via a respective access point configuration settings provisioning manager.
2. An access point policy provisioning manager distributes the configuration settings to region specific controllers. The corresponding one or more controllers update the respective WLAN configurations settings with corresponding thresholds and metrics to monitor the region and provide wireless access accordingly.
3. Assume that a visitor subscriber (such as a user and corresponding communication device belonging to a subscriber of a roaming partner such as X or Z with respect to service provider H) attempts to discover the network upon processing the beacon frames received from surrounding application server. The visitor subscriber communication device includes its home network service provider identity in a respective discovery request communicated in the network environment.
4. A receiving access point processes the received discovery request from the visitor communication device and checks the current CAC (Connection Admission Control) & CLB (Client Load Balancing) configuration settings and current state of wireless access thresholds.
   a. If the receiving access point is operating below thresholds set for visitor communication devices, then the wireless access point operated by the service provider H will honor the discovery request and allow the requesting visitor communication device to proceed with association and use of the wireless access point to access network 190.
   b. If the wireless access point operating with respect to a threshold detects that no more client devices are allowed for the respective partner service provider, then the wireless access point triggers a so-called “neighbor report message” with a recommended target access point list, steering the requesting visitor communication device to a different wireless access point that is not overloaded.
   c. The wireless access point receiving a respective request may query the controller to obtain a respective neighbor access point AP list indicating nearby wireless access points for possible use by the visitor communication device to be provided wireless services.
5. Upon denial of wireless access by the wireless access point, the requesting visitor communication device will switch its generated network association attempt towards an appropriate neighbor access point suggested in neighbor report message.
6. Assuming that the neighbor wireless access point of the wireless network service provider H is operating below set threshold limits, the neighbor wireless access point allows the client association and client device to complete the rest of the authentication flow. The visitor communication devices is then allowed wireless network 190 access through the neighbor wireless access point.

As a more specific example, the data flow 300 in FIG. 3 illustrates wireless access control applied to a visitor communication device 122 as discussed herein.

As previously discussed, the home service provider H, via entity 305 or other suitable entity, generates configuration settings 149-1 defining access control with respect to use of wireless access points deployed by the service provider H in network environment 100. Via communications 315, the service provider H and/or corresponding entity 305 communicates the configuration settings 149-1 to the access point provisioning manager 141.

Via communications 320, the access point provisioning manager 141 forwards the configuration settings 149-1 (wireless access control settings) to the controller 140. Via communications 325, the controller 140 communicates the configuration settings 149-1 to the wireless access point 132.

Via communications 330, the controller 140 communicates the configuration settings 149-1 to the wireless access point 131.

Accordingly, each of the wireless access points 131, 132, etc., in the network environment 100 that is operated by the service provider H are made aware of how to control corresponding wireless access of home and visitor communication devices with respect to the network 190 based on the configuration settings 149-1.

As further discussed herein, the wireless access points provide wireless access in accordance with the configuration settings 149-1.

For example, as further shown, the wireless access point 131 and corresponding communication management resource 131-1 implement corresponding function CNT1 to keep track of the different types of communication devices currently provided wireless access through the wireless access point 131 to the network 190. As previously discussed, assume that the wireless access point 131 provides wireless connectivity to home mobile communication devices H1, H2, H3, etc. Further, assume that the wireless access point 131 provides wireless connectivity to visitor mobile communication devices VX1, VX2, VX3, etc. Via the corresponding function CNT1, the communication management resource 131-1 keeps track of this wireless connectivity such as number of supported communication devices and/or amount of used bandwidth.

Wireless access point 132 and corresponding communication management resource 132-1 implement corresponding function CNT2 to keep track of the different types of communication devices currently provided wireless access through the wireless access point 132 to the network 190. As previously discussed, assume that the wireless access point 132 provides wireless connectivity to home communication devices H5, H6, etc. Further, assume that the wireless access point 132 provides wireless connectivity to visitor communication devices VX5, etc. Via the corresponding function CNT2, the communication management resource 131-1 keeps track of this wireless connectivity.

Via communications 335 (such as including beacons), the wireless access point 131 provides wireless notification of availability of wireless services provided by the wireless access point 131. The wireless communications 335 may include an indication of identities of the different network service providers (such as service provider H, roaming partner X, etc.) supported by the wireless access point 131. Thus, the wireless access point 131 provides notification that the wireless access point 131 provides wireless access services to home network communication devices that subscribe to service provider H as well as visitor communication devices that subscribe to service provider X (i.e., roaming partner X). Based on the notification, the communication device 122 receiving the beacons determines what service providers are supported.

Via communications 340 (such as including beacons), the wireless access point 132 provides notification of availability of wireless services (associated with different service providers) provided by the wireless access point 132. The wireless communications 340 may include an indication of identities of the different network service providers (such as service provider H, roaming partner X, roaming partner Z, etc.) supported by the wireless access point 132. Thus, the wireless access point 132 provides notification that the wireless access point 132 provides wireless access services to home network communication devices that subscribe to service provider H as well as visitor communication devices that subscribe to service provider X (i.e., roaming partner X).

Assume that the user 109 operating the visitor communication device 122 (subscriber of service provider X and not a subscriber of service provider H) provides input 345 requesting wireless access to network 190 via the wireless access point 131. For example, the user 109 and corresponding visitor communication device attempt to use wireless services associated with service provider X because the notification in the communications 335 indicated that the wireless access point 131 supports wireless connectivity associated with the service provider X.

In response to receiving the request, via communications 350, the communication device 122 communicates a respective discovery request to the wireless access point 131. The wireless access point 131 and corresponding communication management resource 131-1 implement a wireless access management function FCN1 to determine whether or not the communication device 122 should be provided wireless connectivity through wireless access point 131 to the network 190. In one embodiment, the wireless access management function FCN1 receives a service provider identity value (specifying wireless network service provider X) with the request in communications 350, the service provider identity value indicates an identity of wireless network service provider X to which a user 109 of the visitor communication device 122 subscribes. The wireless network service provider X is one of multiple wireless network service providers supported by the first wireless access point 131.

In this example, the wireless access management function FCN1 uses the received configuration settings 149-1 to determine that the wireless access point 131 is allowed to provide a maximum of 5 visitor communication devices wireless (of wireless network service provider X) access to the network 190. Assume that the wireless access point 131 and corresponding communication management resource 131-1 detect a condition such as that the wireless access point 131 already provides 5 communication devices (such as including visitor communication device VX1, visitor communication device VX2, etc.) associated with the service provider X access through the wireless access point 131 to the network 190. Accordingly, because the limit of 5 has been reached, the wireless access management function FCN1 determines that no new communication devices (such as communication device 122) associated with the service provider X are going to be allowed wireless access via the wireless access point 131.

In such an instance, prior to authentication of the visitor communication device 122, the wireless access point 131 initiates a respective redirect of the communication device 122 to a different wireless access point. For example, prior to authentication of the corresponding communication device 122 and/or corresponding user 109, in response to detecting the overload condition with respect to visitor communication devices associated with the service provider X, the wireless access point 131 and corresponding communication management resource 131-1 transmit communications 355 to the controller 140. The communications 355 can include a request for an access point list indicating other wireless access points (of wireless network service provider H) operated in the vicinity of the wireless access point 131 and which are potentially available as an alternative way for the visitor communication device 122 to be provided wireless access to the network 190.

Assume in this example, that the controller 140 generates a respective access point list indicating availability of at least wireless access point 132 as a nearby wireless access point candidate for possible use by the visitor communication device 122 and corresponding user 109 to wirelessly access the network 190. Via communications 360, the controller 140 communicates a respective access point list including an identity of at least the wireless access point 132 to the wireless access point 131.

Accordingly, via the wireless access control information (configuration settings 149-1), the communication management resource (wireless access management function FCN1) detects that the first wireless access point 131 has reached a load limit associated with providing wireless access to visitor communication device subscribing to wireless network service provider X; and in response to detecting the load limit: i) produces a neighbor list indicating a group of alternative wireless access points in a vicinity of the first wireless access point 131, and ii) communicates notification of the neighbor list in communications 365 to the communication device 122.

As further shown, the wireless access point 131 and corresponding communication management resource 131-1 communicate the respective access point list including an identity of the wireless access point 132 to the communication device 122 and corresponding user 109. In such an instance, the user 109 and/or corresponding communication device 122 are notified that the wireless access point 122 is unavailable to provide wireless access service to the visitor communication device 122. If desired, the communications 365 can include a respective notification indicating that the communication device 122 and corresponding user 109 are denied wireless access via the wireless access point 131 because the wireless access point 131 has reached its limit (such as number of visitor communication devices or bandwidth) of providing wireless services to subscribers associated with the service provider X.

The communication device 122 uses the access point list (including identity of wireless access point 132) received in communications 365 to determine one or more nearby alternative wireless access points that may be able to provide the communication device 122 wireless access to the network 190. For example, in response to receiving the communications 365, the communication device 122 selects wireless access point 132 from the list and wirelessly transmits communications 370 to the wireless access point 132 as specified by the access point list. The communications 370 can include a discovery request in which the communication device 122 requests wireless access through the wireless access point 132 to the network 190. Additionally, the communications 370 can indicate that the communication device 122 and corresponding user 109 are subscribers of the service provider X and would like to use such services provided by the wireless access point 132.

Prior to providing wireless access to and authentication of the visitor communication device 122, the wireless access point 132 implements the wireless access management function FCN2 to determine if the wireless access point 132 should provide wireless access to the communication device 122 corresponding user 109. In this example, in a similar manner as previously discussed, the wireless access point 132 and corresponding communication management resource 132-1 use the configuration settings 149-1 (received from controller 140) as a basis to determine a maximum #of visitor communication devices associated with the service provider X that are able to use the wireless access point 132. In this example, the wireless access point 132 and corresponding communication management resource 132-1 detect, via configuration settings 149-1) that the wireless access point 132 is able to provide up to a maximum of 3 communication devices associated with the service provider X access to the network 190.

Assume that the wireless access point 132 and corresponding communication management resource 132-1 detect a condition such as that the wireless access point 132 does not already provide 3 communication devices (such as including visitor communication device VX5, etc.) associated with the service provider X access through the wireless access point 132 to the network 190. Accordingly, the wireless access management function FCN2 determines that the visitor communication device 122 associated with the service provider X is allowed wireless access via the wireless access point 132.

In response to detecting that there is no overload condition associated with visitor communication devices associated with the service provider X for wireless access point 132, the wireless access point 132 transmits communications 375 (such as a discovery response indicating that wireless network access will be provided) to the visitor communication device 122 operated by the corresponding user 109.

Recall that the visitor communication device 122 has not yet been authenticated yet. In response to receiving notification in communications 375 indicating that visitor communication device 122 may be provided wireless access, via communications 380 the communication device 122 initiates association/authentication with the wireless access point 132 and service provider H to establish a respective wireless communication link 127-2. For example, via further communications 385, the wireless access point 132 provides notification to the controller 140 regarding the intent to provide wireless access through the wireless access point 132 to the network 190. Via further communications 390, the controller 140 provides notification to the authentication server 310 regarding the requested wireless access by the visitor communication device 122.

Via further communications such as including the communication device 122 or corresponding user 109 providing appropriate authentication credentials through the wireless access point 132 to the authentication server 310, the authentication server 310 provides notification to the wireless access point 132 and corresponding communication management resource 132-1 that the visitor communication device 122 has been authenticated to use the wireless access point 132. In such an instance, as further shown in communications 395, the wireless access point 132 provides notification of successful authentication to the visitor communication device 122 as well as corresponding wireless access through the wireless access point 132 to the network 190.

Accordingly, embodiments herein include receiving a request from a first communication device 122 for access to a remote network 190 via a wireless communication link; prior to authenticating the first communication device 122 to access the remote network 199 through a first wireless access point 131, analyzing wireless access control information indicating how to control wireless connectivity with the first wireless access point; and controlling the access associated with the first communication device through the first wireless access point 131 in accordance with the wireless access control information. In other words, the communication management resource as discussed herein denies requested wireless access to the visitor communication device 122 through the wireless access point 131. via the wireless access control information, determining a limit value associated with the first wireless network service provider, the limit value indicating a number of communication devices supported by the wireless access point for the for wireless network service provider. The communication management resource as discussed herein determines a current load value for the first wireless network service provider H; the current load value indicates a current number of communication devices associated with the first wireless network service provider currently being provided access through the first wireless access point to the remote network; and in response to detecting that the current load value is greater than or equal to the limit value as specified by the configuration settings 149-1 first visitor communication devices, the communication management resource as discussed herein prevents authentication of the first communication device 122 to establish the requested wireless communication link with the first wireless access point 131.

Alternatively, note that, in response to detecting that the current load value of visitor communication devices for wireless network service provider X is less than the limit value, the communication management resource as discussed herein can be configured to proceed with allowing the visitor communication device 122 access to the remote network 190 through the wireless access point 131 subsequent to authentication of the communication device 122 to establish the wireless communication link with the first wireless access point and provide the communication device 122 the requested wireless connectivity.

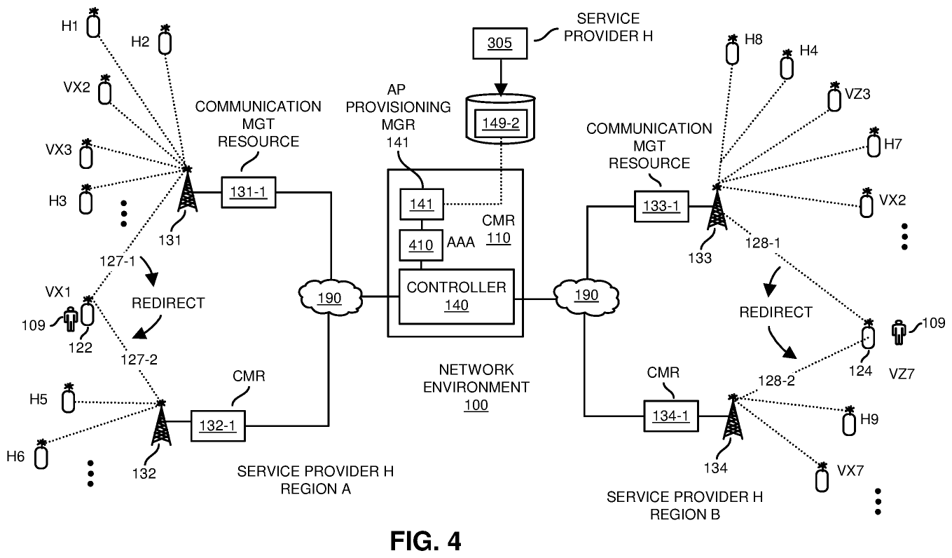

FIG. 4 is an example diagram illustrating a wireless network environment supporting priority wireless access control amongst visitor and home network communication devices as discussed herein.

As shown, in this example embodiment, network environment 100 includes multiple wireless access points including wireless access point 131, wireless access point 132, wireless access point 133, wireless access point 134, etc. Each of the wireless access points provides one or more communication devices wireless access to the network 190.

For example, the wireless access point 131 and corresponding communication management resource 131-1 currently provide one or more communication devices such as communication device H1 (subscriber of service provider H), communication device H2 (subscriber of service provider H), communication device H3 (subscriber of service provider H), . . . , visitor communication device the VX2 (subscriber of service provider X), etc., wireless access to the network 190.

The wireless access point 132 and corresponding communication management resource 132-1 currently provide one or more communication devices such as communication device H5 (subscriber of service provider H), communication device H6 (subscriber of service provider H), . . . , visitor communication device the VX5 (subscriber of service provider X), etc., wireless access to the network 190.

Wireless access point 131 and wireless access point 132 reside in region A supported by the service provider H (a.k.a., home service provider). Communication devices in region can potentially connect to either wireless access point 131 or wireless access point 132 depending on load conditions.

The wireless access point 133 and corresponding communication management resource 133-1 currently provide one or more communication devices such as communication device H4 (subscriber of service provider H), communication device H7 (subscriber of service provider H), communication device H8 (subscriber of service provider H), . . . , visitor communication device VX5 (subscriber of service provider X), visitor communication device the VZ3 (subscriber of service provider Z), etc., wireless access to the network 190.

The wireless access point 134 and corresponding communication management resource 134-1 currently provide one or more communication devices such as communication device H9 (subscriber of service provider H), . . . , visitor communication device the VX7 (subscriber of service provider X), etc., wireless access to the network 190.

Wireless access point 133 and wireless access point 134 reside in region B supported by the service provider H (a.k.a., home service provider). Communication devices in region can potentially connect to either wireless access point 133 or wireless access point 134 depending on load conditions.

As further shown, the network environment 100 further includes an instance of communication management resource 110. Communication management resource 110 includes controller 140, authentication management resource 410, access point provisioning manager 141, etc.

In general, service provider H (via entity 305) produces corresponding configuration settings 149-2 (wireless access control settings) indicating wireless access rules of providing different communication devices access to the network 190 through respective wireless access points. As its name suggests, the access point provisioning manager 141 provisions use of the different wireless access points to provide wireless access services to the different communication devices. Through controller 140, the authentication management resource 410 enforces the configuration settings 149-2 as further discussed herein.

As previously discussed, the implementation of the configuration settings 149-2 provides load-balancing amongst the different wireless access points prior to authentication of the respective communication devices requesting access.

Note further that any of the resources as discussed herein can be implemented via communication management hardware, software, or a combination of hardware and software. For example, each of the communication devices can be implemented as communication management hardware, communication management software, or a combination of communication management hardware and communication management software; each wireless access point can be implemented as wireless access point hardware, wireless access point software, or a combination of wireless access point hardware and wireless access point software; authentication management resource 410 can be implemented as authentication management hardware, authentication management software, or a combination of authentication management hardware and authentication management software; controller 140 can be implemented as controller hardware, controller software, or a combination of controller hardware and controller software; access point provisioning manager can be implemented as access point provisioning hardware, access point provisioning manager software, or a combination of access point provisioning manager hardware and access point provisioning manager software; entity 305 generating the respective configuration settings 149-2 can be implemented as configuration setting generator hardware, configuration settings generator software, or a combination of configuration settings generator hardware and configuration setting generator software; and so on.

Note that the FIGS. 4-6 illustrate a corresponding access point based solution which the corresponding wireless access points provide wireless access to one or more communication devices.

### Authentication Manager Based Solution

1. The service provider H performs the region-based connection admission control and client load balancing via rules provisioning, and AP policy provisioning manager.
2. AP policy provisioning manager distributes the configuration settings (such as access control rules) to the authentication management resource 410 (such as a AAA, Authentication Server/Back end systems).
3. The visiting subscriber communication device 122 (belongs to roaming partner X) and attempts to discover the network upon processing the beacon frames received from a respective wireless access point 131. The visitor communication device 122 device includes its home network service provider identity in any discovery request to the wireless access point 131.
4. The receiving wireless access point 131 receives and processes the received discovery request from the visitor communication device 122 and completes the conventional association procedures.
5. During the device authentication process, the AP/Controller sends the Authentication Request (and service provider identity X) to the authentication management resource 410. The authentication management resource 410 checks the CAC (Connection Admission Control) & CLB (Client Load Balancing) rules and current state of thresholds for the wireless access point 131.
   a. If the wireless access point 131 is currently operating below thresholds set by the configuration settings 149-2, then the wireless access point 131 will honor the discovery request and allow the visitor communication device 122 to compete the association/authentication process.
   b. If wireless access point 131 is operating on a threshold and no more client devices are allowed for the that respective service provider X due to an overload condition, then the wireless access point 131 sends an Authentication Reject message with appropriate error codes (e.g. Overloaded AP apply CAC: connection admission control or CLB: Client load balancing) to the wireless access point 131 and/or visitor communication device 122.
6. Upon receiving the Authentication Reject with error codes, the wireless access point 131 will retrieve a “neighbor report message” and send it to the wireless access point 131 and visitor communication device 122. The list indicates wireless access point 132 to provide wireless services.
7. The visitor communication device 122 switches the network association attempt towards the wireless access point 132 as suggested in the report received from the redirect list.
8. Because the wireless access point 132 is operating below a set threshold, it allows the client association and corresponding visitor communication device 122 to complete the rest of the authentication flow, able to get internet access. Thus, prior to authentication, the visitor communication device 122 is redirected to an appropriate wireless access point 132 that will provide wireless access.

Additional details of providing load-balancing and wireless access control are further discussed below.

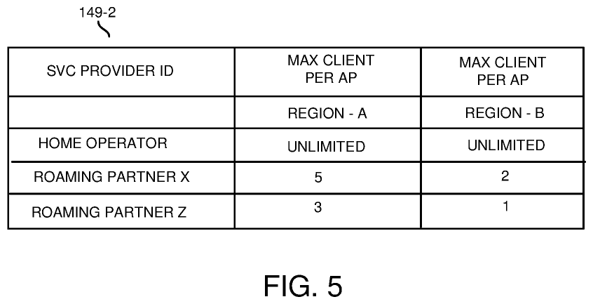

FIG. 5 is an example diagram illustrating wireless access configuration settings for visitor versus home network communication devices as discussed herein.

In this example, as previously discussed, the service provider such as operator H (a.k.a., service provider H) implements multiple wireless access points in multiple regions. The configuration settings 149-2 indicate the wireless access control provided by the service provider H to the different types of supported communication devices (such as home devices or visitor communication devices).

More specifically, the configuration settings 149-2 indicate that the service provider H supports: i) an unlimited number of communication devices that are operated by its own subscribers (home subscribers) for wireless region A, ii) a limited number of 5 communication devices that are operated by visitor communication devices associated with roaming partner X for wireless region A, and iii) a limited number of 3 communication devices that are operated by visitor subscribes associate with roaming partner Z for wireless region A.

Configuration settings 149-2 in this example further indicate that the service provider H supports: i) an unlimited number of communication devices that are operated by its own subscribers (home subscribers) for wireless region B, ii) a limited number of 2 communication devices that are operated by visitor subscribers associated with roaming partner X for wireless region B, and iii) a limited number of 1 communication device that is operated by visitor subscribers associated with roaming partner X for wireless region B.

Note that security agency users or emergency respondents can be provided unlimited/highest priority access.

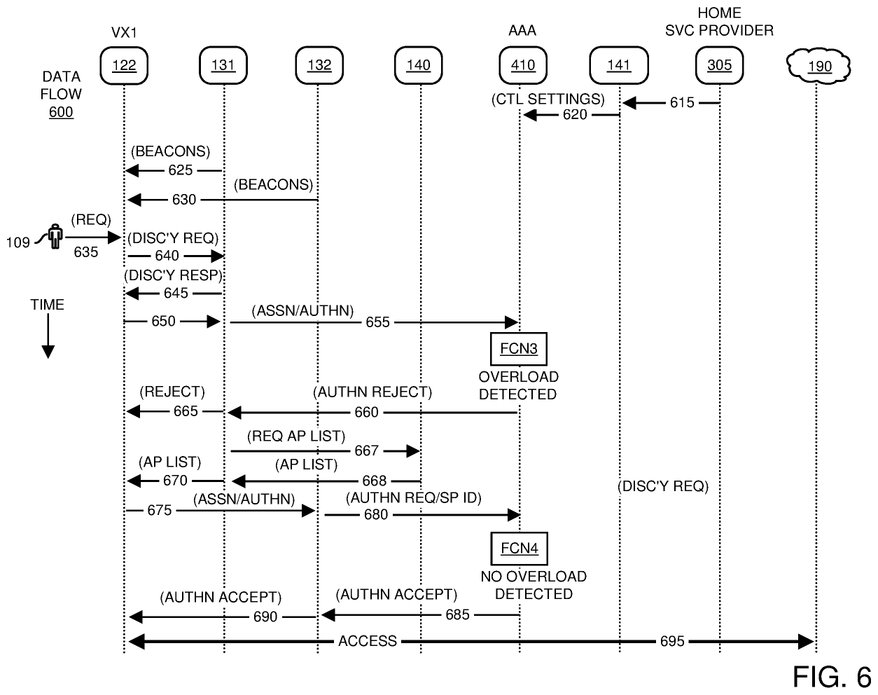

FIG. 6 is an example data flow diagram illustrating wireless access control for a visitor communication device as discussed herein.

As previously discussed, the home service provider H, via entity 305 or other suitable entity, generates configuration settings 149-2 defining access control with respect to use of wireless access points deployed by the service provider H in network environment 100. Via communications 615, the service provider H and corresponding entity 305 communicates the configuration settings 149-2 to the access point provisioning manager 141.

Via communications 620, the access point provisioning manager 141 forwards the configuration settings 149-2 (wireless access control settings) to the authentication management resource 410.

Via communications 625 (such as including beacons), the wireless access point 131 provides wireless notification of availability of wireless services provided by the wireless access point 131 to the visitor communication device 122. The wireless communications 335 may include an indication of identities of the different network service providers (such as service provider H, roaming partner X, roaming partner Z, etc.) supported by the wireless access point 131. Thus, the wireless access point 131 provides notification that the wireless access point 131 provides wireless access services to home network communication devices that subscribe to service provider H as well as visitor communication devices that subscribe to service provider X (i.e., roaming partner X) and wireless network Z (i.e., roaming partner Z). Based on the notification in communications 625, the communication device 122 receiving the beacons determines what service providers are supported.

Via communications 630 (such as including beacons), the wireless access point 132 provides notification of availability of wireless services (associated with different service providers) provided by the wireless access point 132. The wireless communications 630 may or may not include an indication of identities of the different network service providers (such as service provider H, roaming partner X, roaming partner Z, etc.) supported by the wireless access point 131. Thus, the wireless access point 131 can be configured to provide notification that the wireless access point 131 provides wireless access services to home network communication devices that subscribe to service provider H as well as visitor communication devices that subscribe to service provider X (i.e., roaming partner X) and visitor communication devices that subscribe to service provider Z (i.e., roaming partner Z).

Assume that the user 109 operating the visitor communication device 122 (subscriber of service provider X and not a subscriber of service provider H) provides input 635 requesting wireless access via the wireless access point 122. The user 109 and corresponding visitor communication device 122, in response, attempt to use wireless services associated with service provider X because the notification in the communications 625 indicated that the wireless access point 131 supports wireless connectivity associated with the service provider X.

For example, in response to receiving the request (communications 635), via communications 640, the communication device 122 communicates a respective discovery request to the wireless access point 131. The wireless access point 131 responds with a discovery response (via communications 645) to the visitor communication device 122 indicating information to establish wireless connectivity with the wireless access point 131.

The visitor communication device 122 further initiates wireless connectivity with the wireless access point 131 via transmission of communications 650 to the wireless access point 131. The communications 650 indicate that the visitor communication device 122 would like to establish a respective wireless communication link with a particular service provider X.

In response to receiving the communications 650, the wireless access point 131 communicates with the authentication management resource 410 to authenticate the visitor communication device 122 and use of the corresponding wireless access point 131.

In response to receiving the communications 655, the authentication management resource 410 implements wireless access management function FCN3 to determine whether or not the visitor communication device 122 and corresponding user 109 should be allowed wireless access through the wireless access point 131 to the network 190.

For example, the wireless access management function FCN3 uses the received configuration settings 149-2 to determine that the wireless access point 131 is allowed to provide a maximum of 5 visitor communication devices associated with service provider X wireless access to the network 190. Assume that the wireless access point 131 and corresponding communication management resource 131-1 detect a condition such as that the wireless access point 131 already provides 5 communication devices (such as including visitor communication device VX1, visitor communication device VX2, etc.) associated with the service provider X access through the wireless access point 131 to the network 190. Accordingly, because the limit of 5 has been reached, the wireless access management function FCN3 determines that no new communication devices (such as communication device 122) associated with the service provider X are going to be allowed wireless access via the wireless access point 131.

In such an instance, the wireless access management function FCN3 and wireless access point 131 initiate a respective redirect of the communication device 122 to a different wireless access point. For example, prior to authentication of the corresponding communication device 122 and/or corresponding user 109, in response to detecting the overload condition with respect to visitor communication devices associated with the service provider X via access management function FCN3, the wireless access management function FCN3 transmits communications 660 (such as an authentication or usage rejection message prior to actual authentication) to the wireless access point 131. The wireless access point 131 forwards the authentication reject message via communications 665 to the visitor communication device 122. This notifies the visitor communication device 122 that the requested wireless link with the wireless access point 131 has been rejected prior to authentication of the visitor communication device 122.

In response to being notified of the authentication rejection via communications 660, the wireless access point 131 transmits a request for an access point list to the controller 140 via communications 667.

In a similar manner as previously discussed, in response to the request for the access point list in communications 667, the controller 140 generates a respective access point list indicating availability of at least wireless access point 132 as a nearby wireless access point candidate for possible use by the visitor communication device 122 and corresponding user 109 to wirelessly access the network 190. Via communications 668, the controller 140 communicates the generated access point list including an identity of at least the wireless access point 132 to the wireless access point 131.

As further shown, via communications 670, and in response to the rejection, the wireless access point 131 and corresponding communication management resource 131-1 communicate the respective access point list including an identity of the wireless access point 132 to the communication device 122 and corresponding user 109. In such an instance, the user 109 and/or corresponding communication device 122 are notified that the wireless access point 131 is unavailable to provide wireless access service to the visitor communication device 122. If desired, the communications 670 can include a respective notification indicating that the communication device 122 and corresponding user 109 (such as prior to authentication) are denied wireless access via the wireless access point 131 because the wireless access point 131 has reached its limit providing wireless services to subscribers associated with the service provider X.

The communication device 122 uses the access point list received in communications 670 to determine one or more nearby alternative wireless access points that may be able to provide the communication device 122 wireless access to the network 190. For example, in response to receiving the communications 670, the communication device 122 selects wireless access point 132 and wirelessly transmits communications 675 to the wireless access point 132 as specified by the access point list. The communications 675 can include a discovery request and/or association-authentication request in which the communication device 122 requests wireless access through the wireless access point 132 to the network 190. Additionally, the communications 675 can indicate that the communication device 122 and corresponding user 109 are subscribers of the service provider X and would like to use such services provided by the wireless access point 132.

Via communications 680, the wireless access point 132 forwards the authentication request and corresponding identity of the service provider X to the authentication management resource 410. Prior to the wireless access point 132 providing wireless access to and authentication of the communication device 122, the authentication management resource 410 implements the wireless access management function FCN4 to determine if the wireless access point 132 should provide wireless access to the communication device 122 and corresponding user 109. In this example, in a similar manner as previously discussed, the wireless access point 132 and corresponding communication management resource 132-1 use the configuration settings 149-2 as a basis to determine a maximum #of visitor communication devices associated with the service provider X that are able to use the wireless access point 132. In this example, the wireless access point 132 and corresponding communication management resource 132-1 detect that the wireless access point 132 is able to provide up to a maximum of 2 communication devices associated with the service provider X access to the network 190.

Note that the visitor communication device 122 can be configured to further provide, to the authentication management resource 410, any credentials needed to authenticate the visitor communication device 122 use of the wireless services associated with the wireless access point 132.

Assume that the wireless access point 132 and corresponding communication management resource 132-1 detect a condition such as that the wireless access point 132 does not already provide 2 communication devices (such as including visitor communication device VX5, etc.) associated with the service provider X access through the wireless access point 132 to the network 190. Accordingly, the wireless access management function FCN4 implemented by the authentication management resource 410 determines that the visitor communication device 122 associated with the service provider X is going to be allowed wireless access via the wireless access point 132.

In response to detecting that there is no overload condition associated with visitor communication devices associated with the service provider X for wireless access point 132, and based on proper authentication of the visitor communication device 122, the wireless access point 132 transmits communications 685 (such as authentication accept message) to the wireless access point 132 and the visitor communication device 122 operated by the corresponding user 109 via communication 690.

As further shown in communications 695, the wireless access point 132 provides the visitor communication device 122 wireless access through the wireless access point 132 to the network 190 based on authentication of the visitor communication device 122.

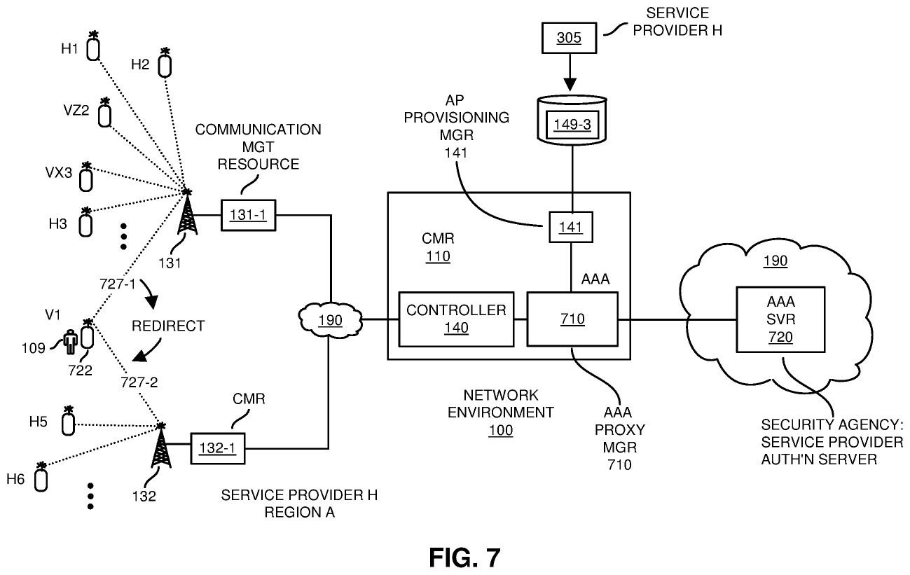

FIG. 7 is an example diagram illustrating a wireless network environment supporting priority wireless access control amongst security agency user communication devices versus home network communication devices as discussed herein.

This section is for one of the use cases for example “Priority access to Priority access to Security agency users to Service provider Wi-Fi network during a security event”.

The call flow sequence is generally the same as the previous section described, the only difference is connection admission control criteria checked in the Serving Service provider AAA and then authentication flow will be proxied to the home operator for authentication.

More specifically, as shown, in this example embodiment, network environment 100 includes multiple wireless access points including wireless access point 131, wireless access point 132, etc. Each of the wireless access points provides one or more communication devices wireless access to the network 190.

For example, the wireless access point 131 and corresponding communication management resource 131-1 currently provide one or more communication devices such as communication device H1 (subscriber of service provider H), communication device H2 (subscriber of service provider H), communication device H3 (subscriber of service provider H), . . . , visitor communication device the VX3 (subscriber of service provider X), etc., wireless access to the network 190.

The wireless access point 132 and corresponding communication management resource 132-1 currently provide one or more communication devices such as communication device H5 (subscriber of service provider H), communication device H6 (subscriber of service provider H), . . . , etc., wireless access to the network 190.

Wireless access point 131 and wireless access point 132 reside in region A supported by the service provider H (a.k.a., home service provider). Communication devices in region can potentially connect to either wireless access point 131 or wireless access point 132 depending on load conditions.

As further shown, the network environment 100 further includes an instance of communication management resource 110. Communication management resource 110 includes controller 140, authentication management resource 410, access point provisioning manager 141, etc.

In general, service provider H (via entity 305) produces corresponding configuration settings 149-3 (wireless access control settings) indicating wireless access rules of providing different communication devices access to the network 190 through respective wireless access points. As its name suggests, the access point provisioning manager 141 provisions use of the different wireless access points to provide wireless access services to the different communication devices. Through controller 140, the authentication management resource 710 (such as authentication manager proxy) enforces the configuration settings 149-3 as further discussed herein.

As previously discussed, the implementation of the configuration settings 149-3 provides load-balancing amongst the different wireless access points prior to authentication of the respective communication devices requesting access.

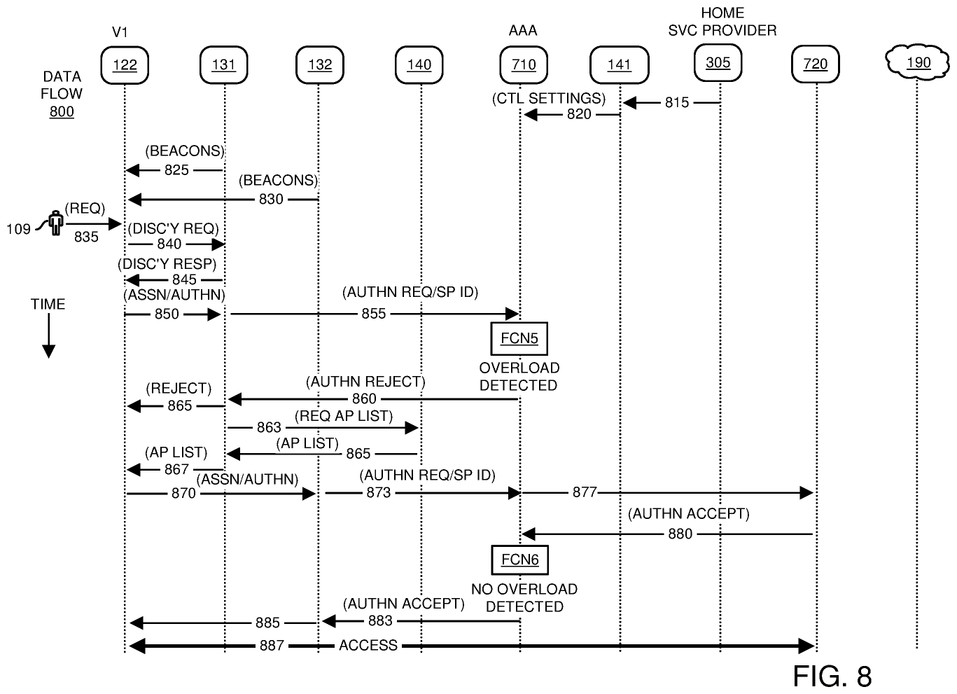

FIG. 8 is an example data flow diagram illustrating wireless access control for a security agency user communication device as discussed herein.

As previously discussed, the home service provider H, via entity 305 or other suitable entity, generates configuration settings 149-3 defining access control with respect to use of wireless access points deployed by the service provider H in network environment 100. Via communications 815, the service provider H and corresponding entity 305 communicates the configuration settings 149-3 to the access point provisioning manager 141.

Via communications 820, the access point provisioning manager 141 forwards the configuration settings 149-3 (wireless access control settings) to the authentication management resource 710.

Via communications 825 (such as including beacons), the wireless access point 131 provides wireless notification (interworking capability) of availability of wireless services provided by the wireless access point 131 to the visitor communication device 122. The wireless communications 825 may include an indication of identities of the different network service providers (such as service provider H, roaming partner X, roaming partner Z, etc.) supported by the wireless access point 131. Thus, the wireless access point 131 provides notification that the wireless access point 131 provides wireless access services to home network communication devices that subscribe to service provider H as well as visitor communication devices that subscribe to service provider X (i.e., roaming partner X). Based on the notification in communications 825, the communication device 122 receiving the beacons determines what service providers are supported.

Via communications 830 (such as including beacons), the wireless access point 132 provides notification of availability of wireless services (associated with different service providers) provided by the wireless access point 132. The wireless communications 830 may or may not include an indication of identities of the different network service providers (such as service provider H, roaming partner X, roaming partner Z, etc.) supported by the wireless access point 131. Thus, the wireless access point 131 can be configured to provide notification that the wireless access point 131 provides wireless access services to home network communication devices that subscribe to service provider H as well as visitor communication devices that subscribe to service provider X (i.e., roaming partner X) and visitor communication devices that subscribe to service provider Z (i.e., roaming partner Z).

Assume that the user 109 operating the visitor communication device 122 provides input 835 requesting wireless access via the wireless access point 131. The user 109 and corresponding visitor communication device 122, in response, attempt to use wireless services associated with service provider X because the notification in the communications 825 indicated that the wireless access point 131 supports wireless connectivity associated with the service provider X.

For example, in response to receiving the request (communications 835), via communications 840, the communication device 122 communicates a respective discovery request to the wireless access point 131. The wireless access point 131 responds with a discovery response (via communications 845) to the visitor communication device 122 indicating information to establish wireless connectivity with the wireless access point 131.

The visitor communication device 122 further initiates wireless connectivity with the wireless access point 131 via transmission of communications 850 to the wireless access point 131. The communications 850 indicate that the visitor communication device 122 would like to establish a respective wireless communication link based on a subscription with a particular service provider X.

In response to receiving the communications 850, the wireless access point 131 communicates with the authentication management resource 710 to authenticate the visitor communication device 122 and use of the corresponding wireless access point 131.

In response to receiving the communications 855, the authentication management resource 710 implements wireless access management function FCN5 to determine whether or not the visitor communication device 122 and corresponding user 109 should be allowed wireless access through the wireless access point 131 to the network 190.

For example, the wireless access management function FCN5 uses the received configuration settings 149-2 to determine that the wireless access point 131 is allowed to provide a maximum of 5 visitor communication devices associated with service provider X wireless access to the network 190. Assume that the wireless access point 131 and corresponding communication management resource 131-1 detect a condition such as that the wireless access point 131 already provides 5 communication devices (such as including visitor communication device VX1, visitor communication device VX2, etc.) associated with the service provider X access through the wireless access point 131 to the network 190. Accordingly, because the limit of 5 has been reached, the wireless access management function FCN5 determines that no new communication devices (such as communication device 122) associated with the service provider X are going to be allowed wireless access via the wireless access point 131.

In such an instance, the wireless access point 131 initiates a respective redirect of the communication device 122 to a different wireless access point. For example, prior to authentication of the corresponding communication device 122 and/or corresponding user 109, in response to detecting the overload condition with respect to visitor communication devices associated with the service provider X via access management function FCN5, the wireless access point 131 and corresponding communication management resource 131-1 transmit communications 860 (such as an authentication rejection message) to the wireless access point 131. The wireless access point 131 forwards the authentication reject message via communications 865 to the visitor communication device 122.

In response to receiving the rejection in communications 860, the communications 863 can include a request for an access point list indicating other wireless access points operated in the vicinity of the wireless access point 131 and which are potentially available as an alternative way for the visitor communication device 122 to be provided wireless access to the network 190.

In a similar manner as previously discussed, in response to the request for the access point list in communications 863, the controller 140 or other suitable entity generates a respective access point list indicating availability of at least wireless access point 132 as a nearby wireless access point candidate for possible use by the visitor communication device 122 and corresponding user 109 to wirelessly access the network 190. Via communications 865, the controller 140 communicates the generated access point list including an identity of at least the wireless access point 132 to the wireless access point 131.

As further shown, via communications 867, the wireless access point 131 and corresponding communication management resource 131-1 communicate the respective access point list including an identity of the wireless access point 132 to the communication device 122 and corresponding user 109. In such an instance, the user 109 and/or corresponding communication device 122 are notified that the wireless access point 122 is unavailable to provide wireless access service to the visitor communication device 122. If desired, the communications 867 can include a respective notification indicating that the communication device 122 and corresponding user 109 are denied wireless access via the wireless access point 131 because the wireless access point 131 has reached its limit providing wireless services to subscribers associated with the service provider X.

The communication device 122 uses the access point list received in communications 867 to determine one or more nearby alternative wireless access points that may be able to provide the communication device 122 wireless access to the network 190.

For example, in response to receiving the communications 867, the communication device 122 wirelessly transmits communications 870 to the wireless access point 132 as specified by the access point list. The communications 870 can include a discovery request and/or association-authentication request in which the communication device 122 requests wireless access through the wireless access point 132 to the network 190. Additionally, the communications 870 can indicate that the communication device 122 and corresponding user 109 are subscribers of the service provider X and would like to use such services provided by the wireless access point 132.

Via communications 873, the wireless access point 132 forwards the authentication request and corresponding identity of the service provider X to the authentication management resource 710. The authentication management resource 710 forwards credentials and/or other information associated with the authentication management resource 720 to authenticate the visitor communication device 122 and corresponding user 109.

In one embodiment, the communication device 122 may subscribe to use of a bit rate of communicating at 200 Megabits per second. Via communications 877, the authentication management resource 710 requests if it is OK to provide the wireless connectivity to the communication device 122 at a rate of 200 Megabits per second (MBS). Via communications 880, the authentication management resource 720 communicates a respective authentication acceptance message to the authentication management resource 710. Additionally, the authentication management resource 720 notifies that the communication device 122 can be provided a lower level of wireless service such as 100 MBS instead of 200 MBS if 200 MBS is not available. Accordingly, embodiments herein support dynamic bandwidth allocation to subscribers.

The authentication management resource 710 implements the wireless access management function FCN6 to determine if the wireless access point 132 should provide wireless access to the communication device 122 corresponding user 109. In this example, in a similar manner as previously discussed, the authentication management resource 710 uses the configuration settings 149-3 as a basis to determine a maximum #of visitor communication devices associated with the service provider X that are able to use the wireless access point 132. In this example, the wireless access point 132 and corresponding communication management resource 132-1 detect at the wireless access point 132 is able to provide up to a maximum of 2 communication devices associated with the service provider X access to the network 190.

Assume that the authentication management resource 710 and corresponding allocation management function FCN6 detect a condition in which the wireless access point 132 is able to support the new wireless connection request by the visitor communication device 122.

In response to detecting that there is no overload condition associated with visitor communication devices associated with wireless access point 132, and based on prior proper authentication of the visitor communication device 122, the wireless access point 132 transmits communications 883 (such as authentication accept message and VSA: priority access enabled) to the wireless access point 132 and the visitor communication device 122 (via communications 885) operated by the corresponding user 109 via communication 690.

As further shown in communications 887, the wireless access point 132 provides the visitor communication device 122 wireless access through the wireless access point 132 to the network 190 based on authentication of the visitor communication device 122.

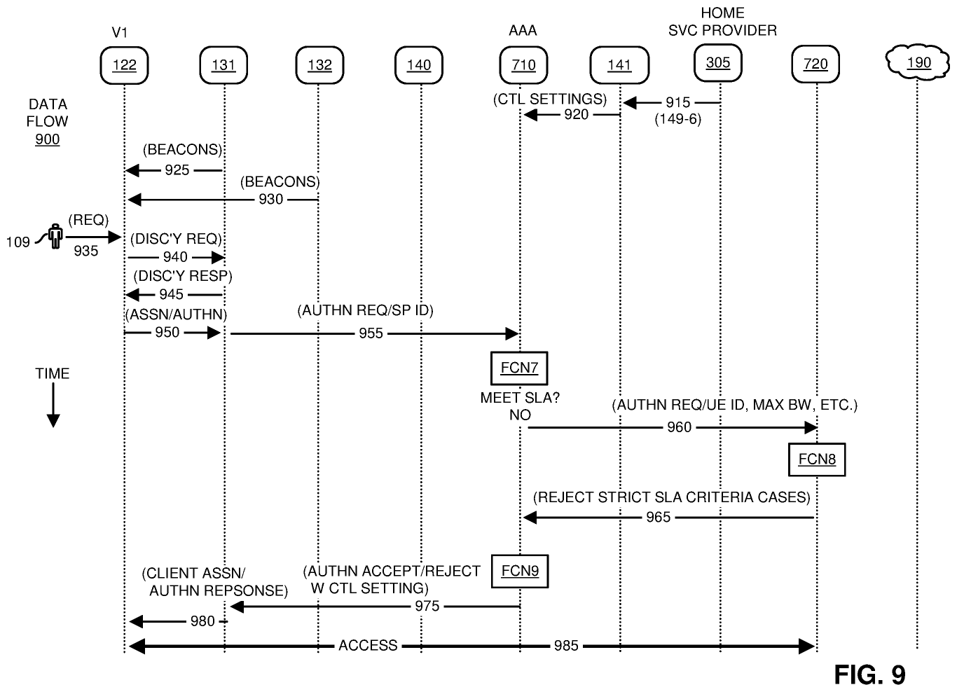

FIG. 9 is an example data flow diagram illustrating wireless access control for a security agency user communication device as discussed herein.

This example includes Dynamic SLA (Service-Level Agreement) negotiation for roaming subscribers from visiting network. For example, the call flow sequence is same as the previous sections described, the only difference is connection admission control criteria and SLA are checked in the Serving Service provider AAA and under network loaded conditions, Serving service provider AAA may notify reduced bandwidth/deviation of SLA details to visitor's home network authentication server (aka Home-AAA). Home AAA will check the users service class, responds (Allow/Reject) accordingly.

As previously discussed, the home service provider H, via entity 305 or other suitable entity, generates configuration settings 149-6 defining access control with respect to use of wireless access points deployed by the service provider H in network environment 100. Via communications 915, the service provider H and corresponding entity 305 communicates the configuration settings 149-6 to the access point provisioning manager 141.

Via communications 920, the access point provisioning manager 141 forwards the configuration settings 149-6 (wireless access control settings) to the authentication management resource 710.

Via communications 925 (such as including beacons), the wireless access point 131 provides wireless notification (interworking capability) of availability of wireless services provided by the wireless access point 131 to the visitor communication device 122. The wireless communications 925 may include an indication of identities of the different network service providers (such as service provider H, roaming partner X, roaming partner Z, etc.) supported by the wireless access point 131. Thus, the wireless access point 131 provides notification that the wireless access point 131 provides wireless access services to home network communication devices that subscribe to service provider H as well as visitor communication devices that subscribe to service provider X (i.e., roaming partner X). Based on the notification in communications 925, the communication device 122 receiving the beacons determines what service providers are supported.

Via communications 930 (such as including beacons), the wireless access point 132 provides notification of availability of wireless services (associated with different service providers) provided by the wireless access point 132. The wireless communications 930 may or may not include an indication of identities of the different network service providers (such as service provider H, roaming partner X, roaming partner Z, etc.) supported by the wireless access point 131. Thus, the wireless access point 131 can be configured to provide notification that the wireless access point 131 provides wireless access services to home network communication devices that subscribe to service provider H as well as visitor communication devices that subscribe to service provider X (i.e., roaming partner X) and visitor communication devices that subscribe to service provider Z (i.e., roaming partner Z).

Assume that the user 109 operating the visitor communication device 122 provides input 935 requesting wireless access via the wireless access point 122. The user 109 and corresponding visitor communication device 122, in response, attempt to use wireless services associated with service provider X because the notification in the communications 925 indicated that the wireless access point 131 supports wireless connectivity associated with the service provider X.

For example, in response to receiving the request (communications 935), via communications 940, the communication device 122 communicates a respective discovery request to the wireless access point 131. The wireless access point 131 responds with a discovery response (via communications 945) to the visitor communication device 122 indicating information to establish wireless connectivity with the wireless access point 131.

The visitor communication device 122 further initiates wireless connectivity with the wireless access point 131 via transmission of communications 950 to the wireless access point 131. The communications 950 can be configured to indicate that the visitor communication device 122 would like to establish a respective wireless communication link with a particular service provider X.

In response to receiving the communications 950, the wireless access point 131 communicates with the authentication management resource 710 to authenticate the visitor communication device 122 and use of the corresponding wireless access point 131. For example, the via communications 955, the wireless access point 131 initiates authentication of the communication device 122 and corresponding user 109. The communications 955 include an identity of the wireless network service provider X to which the user 109 and corresponding visitor communication device 122 are a subscriber.

In response to receiving the communications 955, the authentication management resource 710 implements wireless access management function FCN7 to determine whether or not a service level agreement (such as certain wireless bandwidth as indicated by a respective agreement between the user 109 and the corresponding service provider X) can be provided to the visitor communication device 122 and corresponding user 109 via wireless connectivity through the wireless access point 131 to the network 190. For example, the wireless access management function FCN7 uses the received configuration settings 149-6 to determine that the communication device 122 should be provided 200 megabytes per second wireless service. Assume that the authentication management resource 710 determines via wireless access function FCN7 that the wireless access point 131 (such as based on current load capacity associated with the wireless access point 131 indicating number of communication devices, free bandwidth, etc.) is able to provide a maximum bandwidth of the 100 MBS service to the visitor communication device 122 corresponding user 109 instead of 200 MBS. In such an instance, the authentication management resource 710 transmits communications 960 (such as information including one or more of: an authentication request associated with the visitor communication device 122 to use the wireless access point 131, the unique identifier associated with the visitor communication device 122, maximum bandwidth of 100 MBS available to provide to the visitor communication device 122, etc.) to the third party authentication manager 720.

The third-party authentication manager 720 executes the wireless access function FCN8 to determine if the bandwidth of 100 megabytes per second is sufficient to provide to the communication device 122 instead of the desired 200 MBS.

As determined by function FCN8, if the available bandwidth of 100 MBS is too low to provide to the corresponding communication device 122, the third-party authentication management resource 720 generates a message to include a respective rejection notification to the authentication management resource 710. This notifies the authentication management resource 710 that the request for wireless connectivity by the communication device 122 has been denied.

Alternatively, as determined by function FCN8, if the available bandwidth of 100 MBS is sufficient to provide to the corresponding communication device 122, the third-party authentication management resource 720 generates the message to include a respective accept notification to the authentication management resource 710. This notifies the authentication management resource 710 that the request for wireless connectivity by the communication device 122 has been accepted.

Via function FCN9, the authentication management resource 710 communicates the decision message (or whether to accept the requested service) in communications 975 corresponding control settings to the wireless access point 131. As previously discussed, the message may indicate acceptance or denial of the corresponding requested wireless communication link by the communication device 122. The communications 975 can be configured to include control settings such as to provide 100 MBS service to the visitor communication device 122 or no service.

Assume in this example, that the decision message by the communication management resource 720 indicates acceptance of the communication link at lower bit rate. In such an instance, the wireless access point 131 provides notification of the client in the authentication response of accepting the wireless communication link in communications 980 to the communication device 122.

As further shown in communications 985, the wireless access point 131 provides the visitor communication device 122 wireless access through the wireless access point 132 to the network 190 based on authentication of the visitor communication device 122.

As previously discussed, if the message indicates rejection, the communication device 122 can be redirected to a different wireless access point 132 in a manner as previously discussed if the communication management resource 720 indicates that a lower bit rate is unacceptable. Thus, the authentication management resource 710 can be configured to negotiate a bit rate provided by the wireless access point 131 to the visitor communication device 122 if the full desired bandwidth is unavailable.

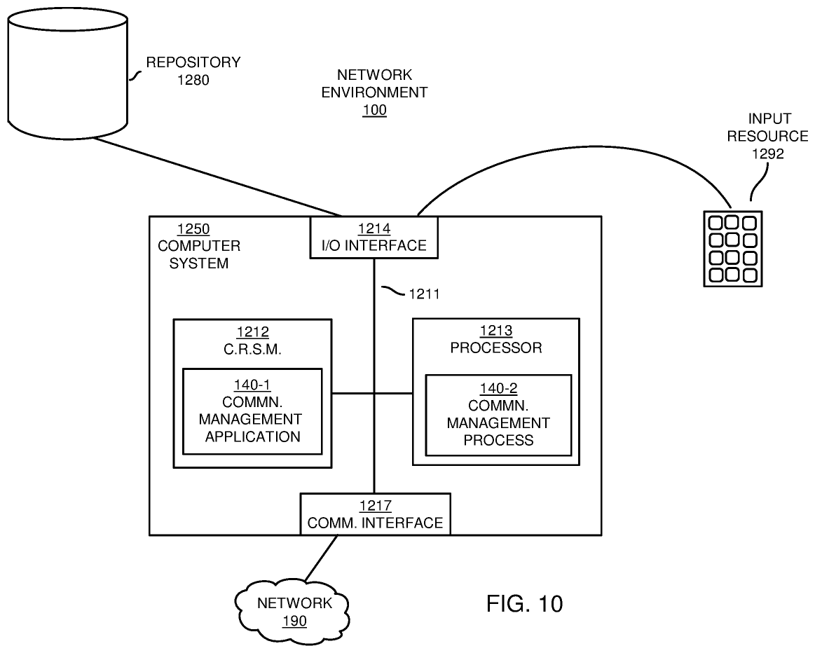

FIG. 10 is an example block diagram of a computer system for implementing any of the operations as previously discussed according to embodiments herein.

Note that any of the resources (such as visitor communication device 122, wireless access point 131, wireless access point 132, controller 140, authentication management resource 710, access point provisioning manager 141, authentication management resource 410, etc.) as discussed herein can be configured to include computer processor hardware, analog/digital circuitry, and/or corresponding executable instructions to carry out the different operations as discussed herein.

As shown, computer system 1250 of the present example includes an interconnect 1211 that couples computer readable storage media 1212 such as a non-transitory type of media (i.e., any type of hardware storage medium) in which digital information can be stored and retrieved, a processor 1213, I/O interface 1214, and a communications interface 1217.

I/O interface(s) 1214 supports connectivity to repository 1280 and input resource 1292.

Computer readable storage medium 1212 (such as computer-readable storage hardware) can be any hardware storage device such as memory, optical storage, hard drive, floppy disk, etc. In one embodiment, the computer readable storage medium 1212 stores instructions and/or data.

As shown, computer readable storage media 1212 can be encoded with management application 140-1 (e.g., including instructions) to carry out any of the operations as discussed herein.

During operation of one embodiment, processor 1213 accesses computer readable storage media 1212 via the use of interconnect 1211 in order to launch, run, execute, interpret or otherwise perform the instructions in management application 140-1 stored on computer readable storage medium 1212. Execution of the management application 140-1 produces management process 140-2 to carry out any of the operations and/or processes as discussed herein.

Those skilled in the art will understand that the computer system 1250 can include other processes and/or software and hardware components, such as an operating system that controls allocation and use of hardware resources to management application 140-1. In accordance with different embodiments, note that computer system may reside in any of various types of devices, including, but not limited to, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 1250 may reside at any location or can be included in any suitable resource in any network environment to implement functionality as discussed herein.

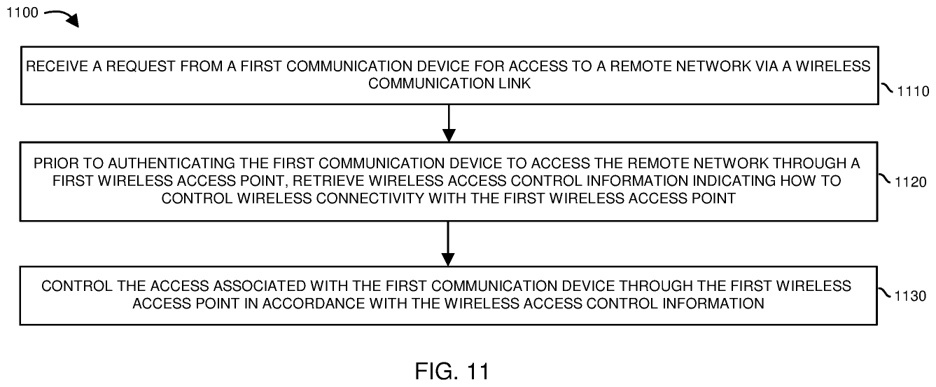

Functionality supported by the different resources will now be discussed via flowcharts in FIG. 11. Note that the steps in the flowcharts below can be executed in any suitable order.

FIG. 11 is a flowchart 1100 illustrating an example method according to embodiments herein. Note that there will be some overlap with respect to concepts as discussed above.

In processing operation 1110, the communication management resource 140 receives notification of a request from a first communication device for access to a remote network via a wireless communication link.

In processing operation 1120, prior to authenticating the first communication device to access the remote network through a first wireless access point, the communication management resource 140 retrieves wireless access control information indicating how to control wireless connectivity of multiple communication devices with the first wireless access point.

In processing operation 1130, the communication management resource 140 controls the access associated with the first communication device via the first access point in accordance with the wireless access control information.

Note again that techniques herein are well suited to facilitate improved use of bandwidth available in a wireless network. However, it should be noted that embodiments herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

We claim:

1. A method comprising:
receiving a request from a first communication device for access to a remote network via a wireless communication link;
prior to authenticating the first communication device to access the remote network through a first wireless access point, analyzing wireless access control information indicating how to control wireless connectivity with the first wireless access point; and
controlling the access associated with the first communication device through the first wireless access point in accordance with the wireless access control information.

2. The method as in claim 1, wherein the request is a discovery request generated by the first communication device.

3. The method as in claim 1, wherein receiving the request includes: receiving a service provider identity value with the request, the service provider identity value indicating an identity of a first wireless network service provider to which a user of the first communication device subscribes, the first wireless network service provider being one of multiple wireless network service providers supported by the first wireless access point.

4. The method as in claim 3, wherein controlling the access associated with the first communication device includes:
via the wireless access control information, determining a limit value associated with the first wireless network service provider, the limit value indicating a number of communication devices supported by the wireless access point for the first wireless network service provider.

5. The method as in claim 4 further comprising:
determining a current load value for the first wireless network service provider, the current load value indicating a current number of communication devices associated with the first wireless network service provider currently being provided access through the first wireless access point to the remote network; and
in response to detecting that the current load value is less than the limit value, proceeding with authentication of the first communication device to establish the wireless communication link with the first wireless access point.

6. The method as in claim 4 further comprising:
determining a current load value for the first wireless network service provider, the current load value indicating a current number of communication devices associated with the first wireless network service provider currently being provided access through the first wireless access point to the remote network; and
in response to detecting that the current load value is greater than or equal to the limit value, preventing authentication of the first communication device to establish the wireless communication link with the first wireless access point.

7. The method as in claim 3 further comprising:
prior to receiving the request, transmitting discovery information from the first wireless access point to the first communication device, the transmitted discovery information indicating identities of multiple wireless network service providers supported by the first wireless access point, the discovery information including the identity of the first wireless network service provider.

8. The method as in claim 1, wherein controlling the access associated with the first communication device in accordance with the wireless access control information includes:
via the wireless access control information, detecting that the first wireless access point has reached a load limit associated with providing wireless access to communication devices subscribing to a first wireless network service provider; and
in response to detecting the load limit: i) producing a neighbor list indicating a group of alternative wireless access points in a vicinity of the first wireless access point, and ii) communicating notification of the neighbor list to the first communication device.

9. The method as in claim 8, wherein the notification prompts the first communication device to access the remote network via a second wireless access point as specified by the neighbor list.

10. The method as in claim 1, wherein controlling the access associated with the first communication device in accordance with the wireless access control information includes:
via the wireless access control information, detecting that the first wireless access point has reached a load limit associated with providing wireless access to communication devices subscribing to a first wireless network service provider; and
in response to detecting the load limit, transmitting a rejection message to the first communication device, the rejection message indicating denial of the access through the first wireless access point to the remote network.

11. The method as in claim 1 further comprising:
controlling the access via authentication management hardware operative to analyze the request from the first communication device to determine whether to proceed with authentication of the first communication device to use the first wireless access point.

12. The method as in claim 1, wherein controlling the access associated with the first communication device includes: subsequent to authenticating the first communication device, and in accordance with the wireless access control information, providing the first communication device the access to the remote network, the method further comprising:
receiving an update to the wireless access control information; and
in response to detecting that the first wireless access point is no longer allowed to access the remote network through the first wireless access point, communicating a communication link termination notice to the first communication device, the communication link termination notice notifying the first communication device of a termination of the access to the remote network through the first wireless access point.

13. The method as in claim 1, wherein controlling the access associated with the first communication device in accordance with the wireless access control information includes:
in response to a first wireless network service provider detecting an inability of the first wireless access point to provide the first communication device a particular bandwidth throughput level of quality as specified by the wireless access control information via the first wireless access point, communicating a message to communication management hardware associated with a second wireless network service provider, the first communication device being a subscriber associated with the second wireless network service provider, the message requesting permission for the first wireless access point to provide the first communication device a reduced bandwidth throughput level of quality with respect to the particular bandwidth throughput level of quality as specified by the wireless access control information.

14. The method as in claim 13 further comprising:
in response to receiving the permission from the second wireless network service provider, providing the first communication device the reduced bandwidth throughput level of quality via the first wireless access point to access the remote network.

15. A system comprising:
communication management hardware disposed in a network environment, the communication management hardware operable to:
receive a request from a first communication device for access to a remote network via a wireless communication link;
prior to authenticating the first communication device to access the remote network through a first wireless access point, retrieve wireless access control information indicating how to control wireless connectivity with the first wireless access point; and
control the access associated with the first communication device through the first wireless access point in accordance with the wireless access control information.

16. The system as in claim 15, wherein the request is a discovery request generated by the first communication device.

17. The system as in claim 15, wherein the communication management resource is further operative to:
receive a service provider identity value with the request, the service provider identity value indicating an identity of a first wireless network service provider to which a user of the first communication device subscribes, the first wireless network service provider being one of multiple wireless network service providers supported by the first wireless access point.

18. The method as in claim 17, wherein the communication management resource is further operative to:
via the wireless access control information, determine a limit value associated with the first wireless network service provider, the limit value indicating a number of communication devices supported by the wireless access point for the first wireless network service provider.

19. The system as in claim 18, wherein the communication management resource is further operative to:
determine a current load value for the first wireless network service provider, the current load value indicating a current number of communication devices associated with the first wireless network service provider currently being provided access through the first wireless access point to the remote network; and
in response to detecting that the current load value is less than the limit value, proceed with authentication of the first communication device to establish the wireless communication link with the first wireless access point.

20. The system as in claim 18, wherein the communication management resource is further operative to:
determine a current load value for the first wireless network service provider, the current load value indicating a current number of communication devices associated with the first wireless network service provider currently being provided access through the first wireless access point to the remote network; and
in response to detecting that the current load value is greater than or equal to the limit value, prevent authentication of the first communication device to establish the wireless communication link with the first wireless access point.

21. The system as in claim 17, wherein the communication management resource is further operative to:
prior to receiving the request, transmit discovery information from the first wireless access point, the transmitted discovery information indicating identities of multiple wireless network service providers supported by the first wireless access point, the discovery information including the identity of the first wireless network service provider.

22. The system as in claim 15, wherein the communication management resource is further operative to:
via the wireless access control information, detect that the first wireless access point has reached a load limit associated with providing wireless access to communication devices subscribing to a first wireless network service provider; and
in response to detecting the load limit: i) produce a neighbor list indicating a group of alternative wireless access points in a vicinity of the first wireless access point, and ii) communicate notification of the neighbor list to the first communication device.

23. The system as in claim 22, wherein the notification prompts the first communication device to access the remote network via a second wireless access point as specified by the neighbor list.

24. The system as in claim 15, wherein the communication management resource is further operative to:
via the wireless access control information, detect that the first wireless access point has reached a load limit associated with providing wireless access to communication devices subscribing to a first wireless network service provider; and
in response to detecting the load limit, transmit a rejection message to the first communication device, the rejection message indicating denial of the access through the first wireless access point to the remote network.

25. The system as in claim 15, wherein the communication management resource is further operative to:
control the access via authentication management hardware operative to analyze the request from the first communication device to determine whether to proceed with authentication of the first communication device to use the first wireless access point.

26. The system as in claim 15, wherein the communication management resource is further operative to:
subsequent to authenticating the first communication device, and in accordance with the wireless access control information, provide the first communication device the access to the remote network;
receive an update to the wireless access control information; and
in response to detecting that the first wireless access point is no longer allowed to access the remote network through the first wireless access point, communicate a communication link termination notice to the first communication device, the communication link termination notice notifying the first communication device of a termination of the access to the remote network through the first wireless access point.

27. The system as in claim 15, wherein the communication management resource is further operative to:
in response to a first wireless network service provider detecting an inability of the first wireless access point to provide the first communication device a particular bandwidth throughput level of quality as specified by the wireless access control information via the first wireless access point, communicate a message to communication management hardware associated with a second wireless network service provider, the first communication device being a subscriber associated with the second wireless network service provider, the message requesting permission for the first wireless access point to provide the first communication device a reduced bandwidth throughput level of quality with respect to the particular bandwidth throughput level of quality as specified by the wireless access control information.

28. The system as in claim 27, wherein the communication management resource is further operative to:
in response to receiving the permission from the second wireless network service provider, provide the first communication device the reduced bandwidth throughput level of quality via the first wireless access point to access the remote network.

29. Computer-readable storage hardware having instructions stored thereon, the instructions, when carried out by computer processor hardware, cause the computer processor hardware to:
receive a request from a first communication device for access to a remote network via a wireless communication link;
prior to authenticating the first communication device to access the remote network through a first wireless access point, retrieve wireless access control information indicating how to control wireless connectivity of multiple communication devices with the first wireless access point; and
control the access associated with the first communication device via the first access point in accordance with the wireless access control information.
